(19) United States
(12) Patent Application Publication
(10) Pub. No.: US 2021/0388700 A1
(43) Pub. Date: Dec. 16, 2021

(54) SHALE FIELD WELLBORE CONFIGURATION SYSTEM

(71) Applicant: Landmark Graphics Corporation, Houston, TX (US)

(72) Inventors: Srinath Madasu, Houston, TX (US); Keshava Prasad Rangarajan, Sugar Land, TX (US)

(21) Appl. No.: 16/899,816

(22) Filed: Jun. 12, 2020

(51) Int. Cl. E21B 43/24; E21B 43/30

(52) U.S. Cl. CPC E21B 43/2401; E21B 43/30

(57) ABSTRACT

Aspects and features of a system for providing parameters for shale field configuration include a processor, and instructions that are executable by the processor. The system, using the processor, can receive resource supply data associated with a shale field to be penetrated by a wellbore or wellbores and simulate production from the shale field using the resource supply data to determine constraints and decision variables. The system can optimize a multi-objective function of the decision variables subject to the constraints to produce controllable parameters for operating the shale field. As examples, these parameters may be related to formation or stimulation of the wellbore or wellbores at the shale field site.

### TECHNICAL FIELD

The present disclosure relates generally to wellbore operations in a shale field. More specifically, but not by way of limitation, this disclosure relates to processing data to determine configuration parameters for the wellbore operations.

### BACKGROUND

Shale formations have sometimes been viewed as non-productive rock by the petroleum industry. But, acceptable production levels can be achieved through using specialized drilling and completion technologies. In shale formations, most of the effective porosity may be limited to the fracture network within the formation, but some hydrocarbons may have also been trapped in the formation matrix, the various layers of rock, or in the bedding planes. To make shale formations economical, fracturing stimulation treatments are often used to connect the natural microfractures in the formation as well as to create new fractures. Thus, successfully developing a shale field often involves more time, planning, and materials than typical for more traditional types of oil and gas fields.

### BRIEF DESCRIPTION OF THE DRAWINGS

FIG. 1 is a cross-sectional view of a portion of a well environment that includes a system for placement of proppant in a wellbore of a shale field according to some aspects of the disclosure.

FIG. 2 is a block diagram of a system for providing shale field wellbore configuration control according to some aspects of the disclosure.

FIG. 3 is timeline diagram illustrating the various stages of development for a shale field site according to some aspects of this disclosure.

FIG. 4 is a data flow diagram illustrating the inputs, outputs, and stages of a process for shale field wellbore configuration control according to some aspects of this disclosure.

FIG. 5 is a flowchart of a process of shale field wellbore configuration control according to some aspects of the disclosure.

FIG. 6 is an example of a Pareto set diagram for shale field planning using a linear model according to some aspects of the disclosure.

FIG. 7 is an example of a Pareto set diagram for shale field planning using a neural network model according to some aspects of the disclosure.

FIG. 8 is a graph illustrating predicted and actual production data for a shale field site using shale field wellbore configuration control according to some aspects of the disclosure.

FIG. 9 is a schematic illustration of a typical supply configuration for a shale field site according to some aspects of this disclosure.

FIG. 10 is a schematic illustration showing detail of a water supply configuration for a shale field site according to some aspects of this disclosure.

### DETAILED DESCRIPTION

Certain aspects and features of the present disclosure relate to modeling the operation of a shale field site for hydrocarbon production through various stages and providing computer-controllable wellbore parameters to improve the efficiency of extracting hydrocarbons from the site. The parameters generated can provide an optimal schedule, optimal configuration of wells, and optimal distribution of resources from various sources to improve, and make more efficient, the operation of the shale field site.

In some aspects, a system includes multi-objective optimization based on a physics-based model, which may be combined with a machine-learning model for shale field planning and material supply management. The optimization can be carried out to satisfy constraints, such as cost constraints, limits on available power, limits on materials, and time limits. Controllable parameters provided by the system can include wellbore configuration parameters such as number of wells, length of wells, and number of fractures for each well. Controllable parameters provided by the system can also include a distribution plan of proppant from multiple sources or a distribution plan of water from multiple sources. By reducing or eliminating trial and error, the system can facilitate operation of a shale field site more efficiently and at lower cost.

Aspects and features include a system for shale field planning that can take into account supply chain, operations, midstream processing, downstream processing, and multiple other factors beyond economic considerations. In some examples, constraints can include environmental constraints, which can avoid aquifer contamination and can take into account regulatory standards. The system can meet multiple objectives of different service lines. In some examples, the system can perform physics-based and machine-learning modeling using a hybrid cloud and edge-based computation platform. Multi-objective optimization can include environmental objectives and risk factors. Planning information provided can cover operations from exploration to end use.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

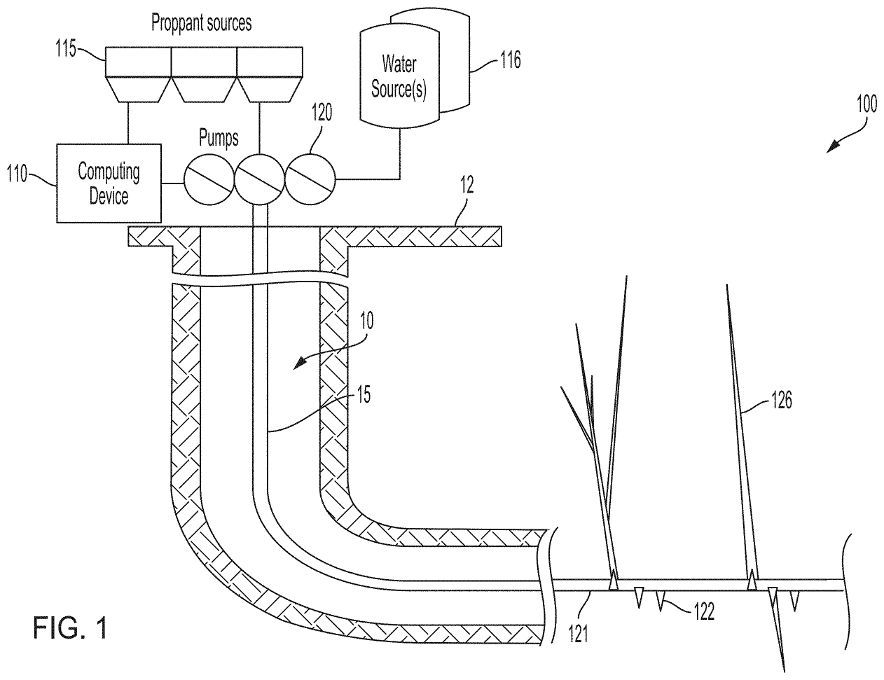

FIG. 1 is a cross-sectional view of an example of a well system 100 including a wellbore 10 in a shale formation 12. A tubing string 15 is deployed in wellbore 10 and can be used to pump proppant mixed with water or other materials into the wellbore. The proppant material may be, for example, a biodegradable polymer. The proppant material is typically formed into a particulate and the particle size can be varied. Proppant added to a fluid to be applied to a wellbore can include a distribution of particles of various sizes. In some aspects, the computing device 110 can dynamically produce proppant of an optimal particle size distribution and an optimal cost by accessing multiple proppant sources 115 and apply the proppant to the wellbore using water from water sources 116. The computing device 110 can operate pump or pumps 120 to pump fluid into the wellbore 10.

Wellbore 10 includes a horizontal section, which further includes a portion 121 of tubing string 15. Tubing string portion 121 includes perforations 122. Each perforation represents a location where fracturing fluid with proppant can be placed to cause fractures 126. The proppant holds fractures 126 open after any fracturing treatment is completed. Some of the controllable parameters for shale site wellbore configuration that can be optimized by a system according to some examples include wellbore length, number of fractures to be produced over that length, the mix of water from various sources used in fracturing, and the mix of proppant from various sources used in fracturing.

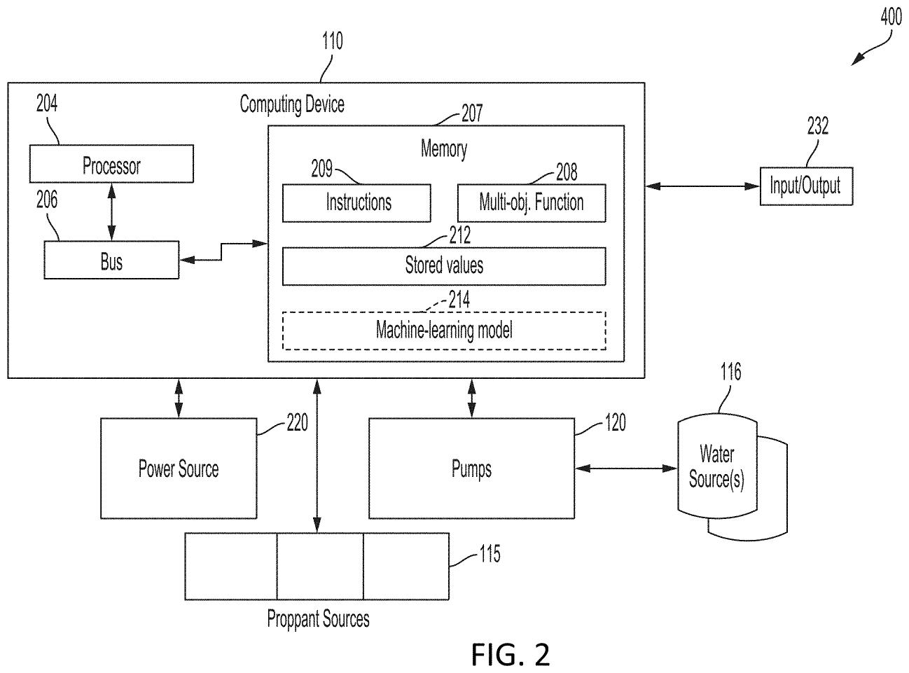

FIG. 2 is a block diagram of a system for providing shale field wellbore configuration control according to some aspects of the disclosure. In some examples, the components shown in FIG. 2 (e.g., the computing device 110 and power source 220) can be integrated into a single structure. For example, the components can be within a single housing. In other examples, the components shown in FIG. 2 can be distributed (e.g., in separate housings) and in electrical communication with each other, such as in a distributed computing system architecture.

The system 200 includes a computing device 110. The computing device 110 can include a processor 204, a memory 207, and a bus 206. The processor 204 can execute one or more operations for determining optimal wellbore configuration parameters for a shale field, using a multi-objective function 208 stored in memory 207. The processor 204 can execute computer-readable program instructions 209 stored in the memory 207 to perform the operations. The processor 204 can include one processing device or multiple processing devices. Non-limiting examples of the processor 204 include a Field-Programmable Gate Array (“FPGA”), an application-specific integrated circuit (“ASIC”), a microprocessor, etc.

The processor 204 can be communicatively coupled to the memory 207 via the bus 206. The non-volatile memory 207 may include any type of memory device that retains stored information when powered off. Non-limiting examples of the memory 207 include electrically erasable and programmable read-only memory (“EEPROM”), flash memory, or any other type of non-volatile memory. In some examples, at least part of the memory 207 includes a medium from which the processor 304 can read instructions. A non-transitory computer-readable medium can include electronic, optical, magnetic, or other storage devices capable of providing the processor 204 with computer-readable instructions or other program code. Non-limiting examples of a computer-readable medium include (but are not limited to) magnetic disk(s), memory chip(s), ROM, random-access memory (“RAM”), an ASIC, a configured processor, optical storage, or any other medium from which a computer processor can read instructions. The instructions can include processor-specific instructions generated by a compiler or an interpreter from code written in any suitable computer-programming language, including, for example, C, C++, C#, etc.

In some examples, the computer program instructions 209 can perform operations for determining which proppant sources and water sources to use, and for determining distribution of these and other resources to a wellbore in real time. These operations can, as an example, make use of stored values 212 for timing or duration of certain operations, constraints, and costs. Instructions 209 can also optionally make use of a machine-learning model 214 to project optimal wellbore lengths and fracture configuration parameters for wells at a given shale site.

The system 200 can include a power source 220. The power source 220 can be in electrical communication with the computing device 110. In some examples, the power source 220 can include a battery or an electrical cable (e.g., a wireline). In some examples, the power source 220 can include an AC signal generator. The computing device 110 can in some aspects control proppant distribution among proppant sources 115 as well as water distribution from water sources 116. System 200 in this example also includes input/output interface 232. Input/output interface 232 can connect to a keyboard, pointing device, display, and other computer input/output devices, including a wires or wireless network adapter for remote access or to send proppant information or other information to a remote location. An operator may provide input using the input/output interface 232. Indications of projected timing or a history of past events related to the operation of the system can also be displayed to an operator through a display that is connected to or is part of input/output interface 232.

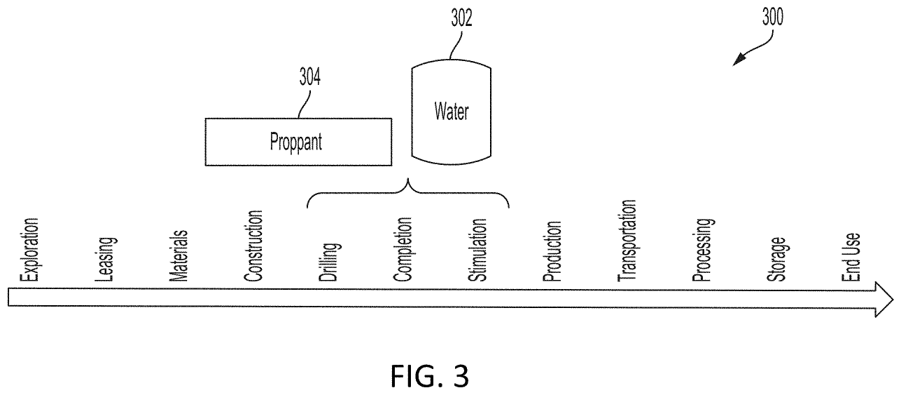

FIG. 3 is timeline diagram 300 illustrating the various stages of development for a shale field site according to some aspects of this disclosure. The timeline diagram 300 begins with exploration, leasing, and acquiring and delivering materials that can be used in the construction of the site. Once the site is constructed, drilling, completion, and stimulation of the wellbores can occur. Hydrocarbons are then produced, transported, and processed. Hydrocarbons may be stored. Once the shale field site has ceased to produce hydrocarbons, or the hydrocarbons being produced below a threshold for profitability, the site may be converted for an end use.

As shown in the timeline diagram 300, water 302 and proppant 304 are used in drilling, completion, and stimulation. The optimization process according to some examples can be used at any or all of these stages.

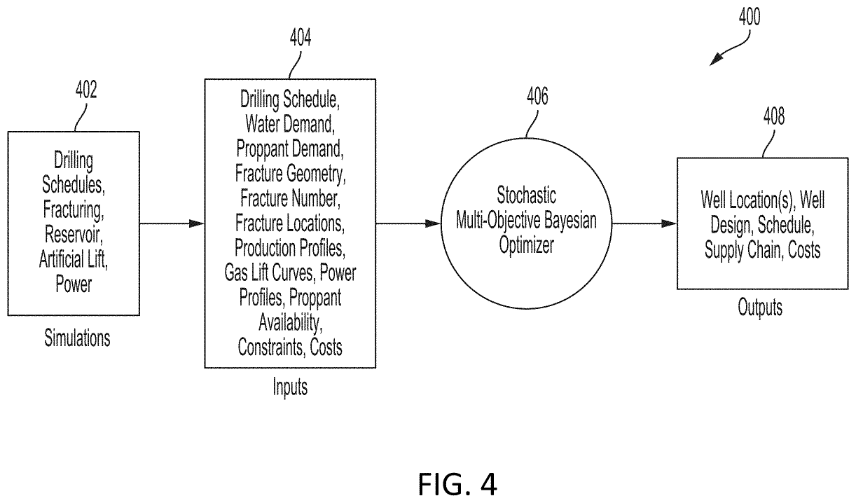

FIG. 4 is a data flow 400 illustrating the inputs, outputs, and stages of a process for shale field wellbore configuration control according to some aspects of this disclosure. Simulations 402 run drilling schedules, simulate fracturing, simulate characteristics of the reservoir, simulate artificial lift, and simulate power consumption. Simulating production can include modeling the production using a linear model or a hybrid physics-based, machine-learning model. A hybrid physics-based, machine-learning model can combine inputs produced by a physics-based model with other inputs, such as inputs gathered from measured data for the specific shale field. The simulations determine constraints that are not already known and decision variables for wellbores that are to be formed in the shale field. The simulations 402 provide inputs 404 to the stochastic, multi-objective, Bayesian optimizer 406. The inputs can include any or all of a drilling schedule, water demand, proppant demand, power demand, fracture geometry, fracture number, fracture locations, production profiles, gas lift curves, power profiles, proppant availability, constraints, and costs. The inputs can also include capital expenditures (CAPEX) and operational expenditures (OPEX).

The inputs used to generate production profiles together with geometry computations for the shale field can influence well pad design. Constraints can include capacity constraints, mass balance constraints, resource availability constraints and local constraints imposed by the location of the shale field or the timing of events. Bayesian optimizer 406 provides outputs 408 based on inputs 404. These outputs can include any or all of well locations, production parameters, stimulation parameters, schedules, supply chain distribution parameters, and costs.

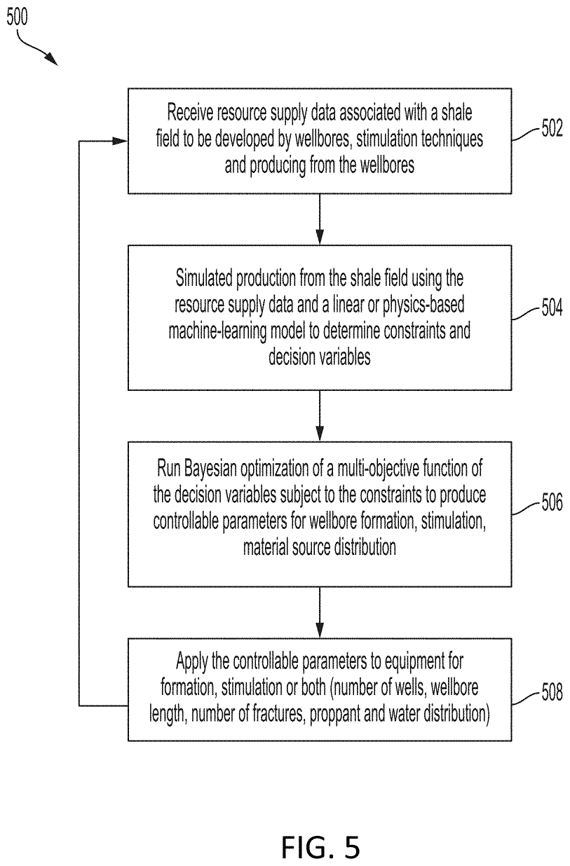

FIG. 5 is a flowchart of a process 500 of shale field wellbore configuration control according to some aspects of the disclosure. At block 502, processor 204 receives resource supply data associated with shale field to be developed by forming wellbores, applying stimulation techniques, and producing hydrocarbons from the wellbores. At block 504, processor 204 simulates production from the shale field using the resource supply data in a linear or a hybrid, physics-based, machine-learning model to determine constraints and decision variables for configuring and operating the shale site. At block 506, the Bayesian optimizer 406 is run to optimize a multi-objective function of the decision variables subject to the constraints in order to produce controllable parameters for wellbore formation, stimulation, or both. At block 508, processor 204 applies the controllable parameters to equipment for formation, stimulation, or both. Parameters can include, as examples, the number of wells at the site, wellbore length, number of fractures per well, as well as distribution of proppant and water from various sources.

Examples of shale field planning and configuration can include configuring four wells in an optimized shale gas network, including fracturing and production. The examples can use multi-objective optimization that includes economic and environmental objectives, as well as production and scheduling objectives. Distribution of supplied resources from among sources of both water and proppant are taken into account. The examples can produce projections of optimized controllable parameters for the shale field including the length of the wells and the number of fractures per well. Decision variables include an amount of proppant from each available source and amount of water from freshwater sources and onsite well treatment. Constraints include a maximum length for a well and a maximum number of fractures for a well. Constraints also include water capacity and a maximum amount of proppant that can be obtained from each source. The examples can include eight decision variables.

To perform the optimization for the examples:

$$Objective Function - NPV = {\sum }_{i = 1}^{N} {DCF}_{n} - {C}_{Capex}$$

$${DCF}_{n} = ( 1 - T ) [ {q}_{n} G ( 1 - R ) - {C}_{LOC} ] {e}^{- it} \text{?} , \\ \text{?} \text{indicates text missing or illegible when filed}$$

where T is the tax rate and is set at 30%, and q is the production rate and is assumed to be a linear function of the well length and number of fractures for each well, aL+bN+C, where a, b, and c, are constants. G is the gas price, R is the royalty rate and is set at 15%, and C_{LOC} is the lease operating cost and is set at $150/day. The capital expenditure cost is:

C_{Capex}=C_{Lease}+C_{Drill}+C_{Frac},

where C_{Lease} is set at $1.2 M or $1000/acre, C_{Drill} is set at $250/foot, both vertical and horizontal, and C_{Frac} is set at $250,000 per stage.

For illustrative purposes, the four wells to be operated at the shale field site of interest can be numbered 1, 2, 3, and 4, and the constraints include a limit of 30 fractures per well, a limit on the length of wells 1, 3, and 4 of 5000 feet and on the length of well 2 of 3000 feet. These constraints and assumptions make the cost function:

DCFₙ=(0.7)[(−0.5*L+200*N+581528100)3(0.85)−1280000]−(120000+250*(L)+250000*N)+(0.7)[(−0.4*L+100*N+481528100)3(0.85)−1280000]−(120000+250*(L)+250000*N)+(0.7)[(−0.25*L+50*N+681528100)3(0.85)−1280000]−(120000+250*(L)+250000*N)+(0.7)[(−0.75*L+300*N+381528100)3(0.85)−1280000]−(120000+250*(L)+250000*N).

Total proppant needed is set at 2000 pounds. Four suppliers are available to supply up to 1000 pounds at a cost of 25 c/lb., up to 3000 pounds at a cost of 50 c/lb., up to 1000 pounds at a cost of 35 c/lb., and up to 500 pounds at a cost of 20 c/lb., respectively. For computing the amount of proppant to obtain from each supplier:

Cost=25*x1+50*x2+35*x3+20*x4,

Constraint=x1+x2+x3+x4=2000.

The range for x1 is 0-1000, for x2 is 0-3000, for x3 is 0-1000, and for x4 is 0-500.

Total water needed is set to 2000 gallons. Three fresh-water sources with 1000 gallons, 3000 gallons, and 1000 gallons are available. Onsite water treatment serves as a fourth source of up to 500 gallons. This cost of obtaining water from these four sources is 25 c/gal., 50 c/gal., 35 c/gal., and 20 c/gal., respectively, making the cost equation, constraint equation, and ranges the same for water and proppant. Optimal results for shale field planning can be obtained using multi-objective Bayesian optimization in eight dimensions with two objectives for proppant and water as described above. Similarly, distribution among sources (suppliers) for the proppant and water are obtained using multi-objective Bayesian optimization.

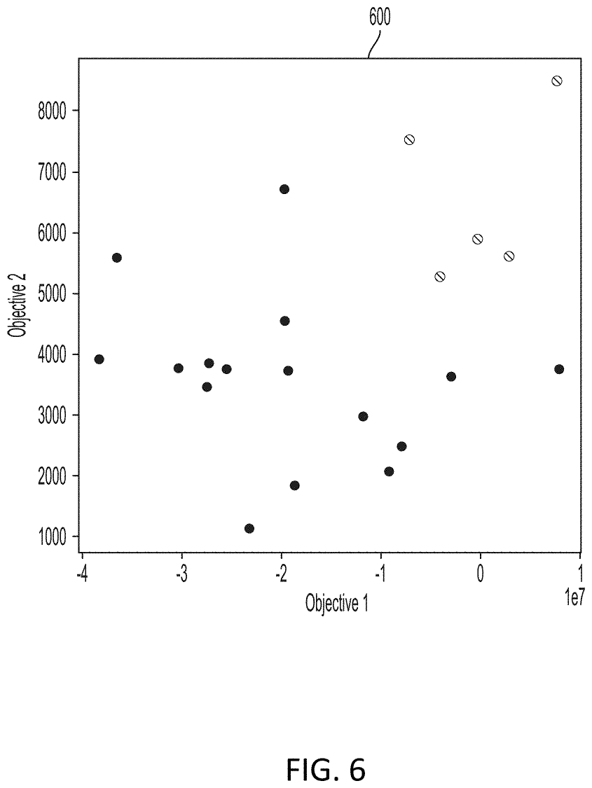

FIG. 6 is a Pareto set diagram 600 for solving the above using a linear model for production simulation. The optimal solution computed by the Bayesian optimizer is:

| | | | |
|---|---|---|---|
| x: array([[5.00000000e+02, | 6.00000000e+00, | 6.00000000e+02, | 6.00000000e+00, |

| | | | |
|---|---|---|---|
| 0.00000000e+00, | 2.10000000e+01, | 1.00000000e+03, | 1.00000000e+01], |
| [1.99598874e+03, | 1.51424468e+01, | 1.62155746e+03, | 1.68618575e+01, |
| 5.23463002e+02, | 3.34767374e+00, | 3.53148265e+03, | 2.82843117e+01], |
| [2.08481527e+02, | 1.50418579e+01, | 1.55060731e+03, | 4.75338701e+00, |
| 2.86803153e+03, | 4.22250369e+00, | 2.15370958e+03, | 1.87726172e+01], |
| [1.17567196e+03, | 1.50455882e+01, | 3.02549096e+02, | 3.57314337e+00, |
| 1.41073924e+03, | 2.42722386e+01, | 4.46819012e+03, | 2.81036469e+01]]) |

X is the array containing the solution. The first two elements in the array represent the well length and number of fractures for the first well followed by the second, followed by the third, followed by the fourth well. The third solution would most likely be selected. The third solution suggests that, approximately, well 1 should be 200 feet long with 15 fractures, well 2 should be 1550 feet long with 5 fractures, well 3 should be 2868 feet long with 4 fractures, and well 4 should be 2153 feet long with 19 fractures.

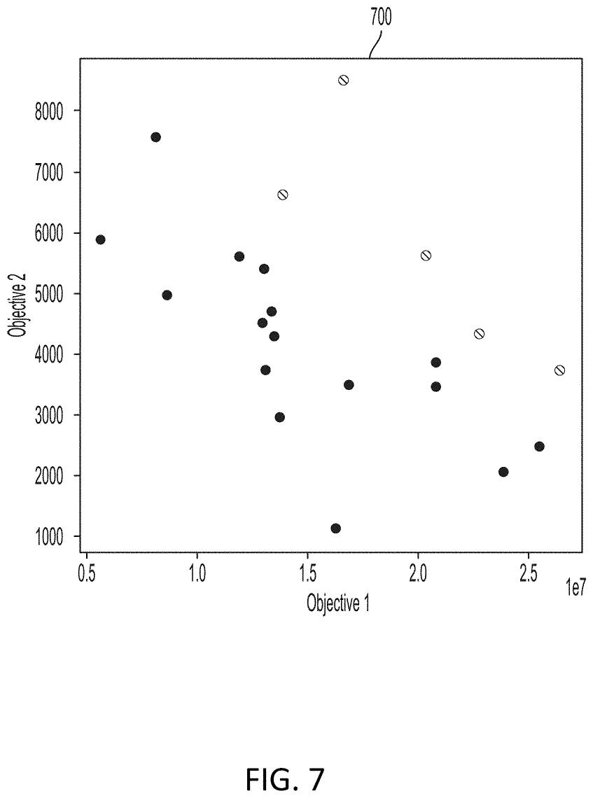

FIG. 7 is a Pareto set diagram 700 for providing a solution with the same assumptions and constraints as described above, but using a machine-learning, neural network model for production simulation. The neural network includes two layers with ten nodes each, and both rectified linear and linear activation functions. The optimal solution computed by the Bayesian optimizer in this case is:

| | | | |
|---|---|---|---|
| x: array([[3.00000000e+03, | 1.80000000e+01, | 1.80000000e+03, | 1.80000000e+01, |

| | | | |
|---|---|---|---|
| 2.50000000e+03, | 1.80000000e+01, | 0.00000000e+00, | 0.00000000e+00], |
| [5.0000000e+02, | 6.00000000e+00, | 6.00000000e+02, | 6.00000000e+00, |
| 0.00000000e+00, | 2.10000000e+01, | 1.00000000e+03, | 1.80000000e+01], |
| [0.00000000e+00, | 3.00000000e+00, | 3.00000000e+02, | 3.00000000e+00, |
| 5.00000000e+03, | 1.20000000e+01, | 5.00000000e+02, | 1.50000000e+01], |
| [3.50000000e+03, | 2.10000000e+01, | 2.10000000e+03, | 0.00000000e+00, |
| 3.00000000e+03, | 0.00000000e+00, | 3.00000000e+03, | 3.00000000e+00], |
| [3.93673075e+03, | 1.21186824e+01, | 2.61649133e+03, | 1.74408908e+01, |
| 1.40826395e+03, | 6.88701500e+00, | 1.80901810e+03, | 5.08542114e+00], |
| [7.45984596e+02, | 8.25455944e+01, | 9.24546367e+02, | 8.90403833e+00, |
| 3.10703542e+03, | 1.82889063e+01, | 4.10377279e+03, | 5.02684581e+00]]) |

The array X contains the solution. As before, the first two elements in the array represent the well length and number of fractures for the first well followed by the second, followed by the third, followed by the fourth well. In this case, the fifth solution is selected by the system. The fifth solution suggests that, approximately, well 1 should be 3936 feet long with 12 fractures, well 2 should be 2616 feet long with 17 fractures, well 3 should be 1408 feet long with 7 fractures, and well 4 should be 1809 feet long with 5 fractures.

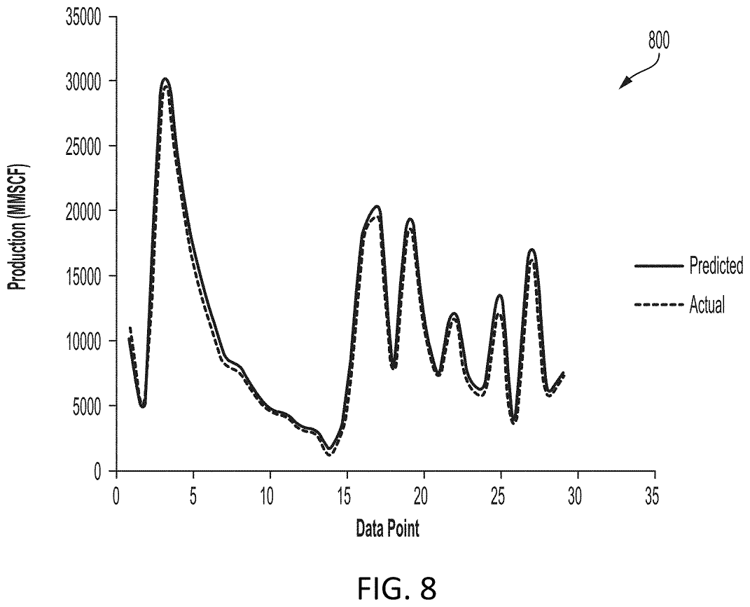

FIG. 8 is a graph 800 illustrating predicted and actual production data for a shale field site using shale field wellbore configuration control using the neural network as described above. Production for the rest of the three wells was assumed to be 25% lower than the first well, 75% lower than the first well, and 50% more than the first well. Thirty data points were used for demonstration purposes. The accuracy is more than 95% for the projections made above, which are represented by the dashed line. Actual production is represented by the solid line.

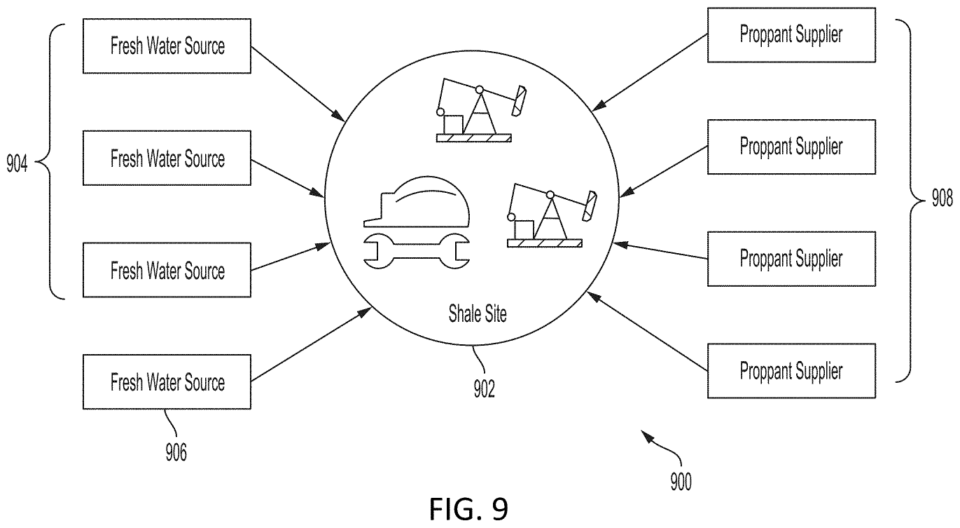

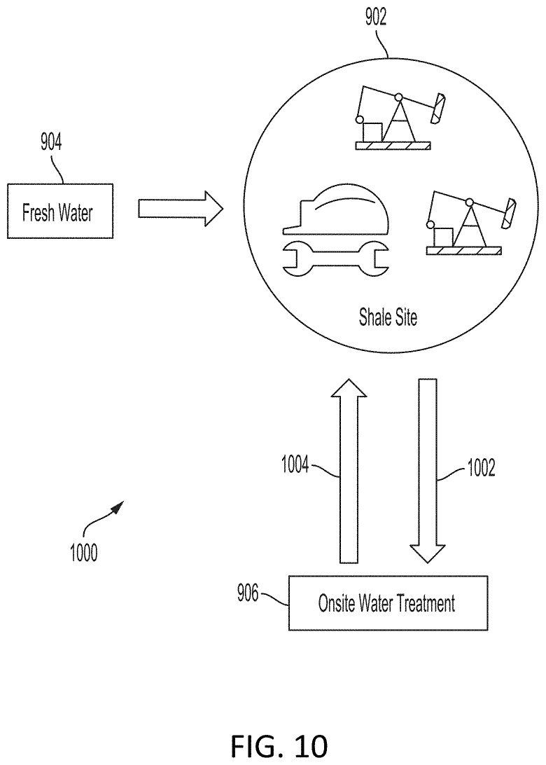

FIG. 9 and FIG. 10 illustrate water and proppant supply source configurations described with respect to using a system according to some examples to project optimal distribution of proppant and water across sources with the constraints described above. FIG. 9 is a schematic illustration of the typical supply configuration 900 for the shale field site in this example. Shale site 902 is supplied by water from the various sources. Water is used in both formation of wellbores through drilling, and in stimulation of wellbores by hydraulic fracturing. In the example of FIG. 9, water can be supplied from the three freshwater sources 904. Another source of water in this example is onsite treatment 906. Onsite treatment can be used to treat wastewater and recycle it for use in drilling or fracturing.

Supply configuration 900 in this example also includes the four proppant sources 908 as discussed above. Certain aspects and features of the present disclosure can allow optimization of distribution of resources such as water and proppant across various sources, subject to constraints.

FIG. 10 is a schematic illustration showing more detail of the water supply a configuration 1000 for a shale field site as illustrated in FIG. 9. Shale site 902 is supplied by fresh water sources 904 as previously described. Onsite treatment 906 receives a wastewater flow 1002, treats the water, and outputs fresh water 1004 to supply fresh water to shale site 902 in addition to that supplied to shale site 902 by fresh water sources.

The optimal distribution of proppant from the available sources as described above can be projected by maximizing NPV and minimizing cost. The optimal solution in this example computed by the Bayesian optimizer based on simulation using the linear model is:

x: array([[1.00000000e+03, −2.83952587e−14, 5.05051764e+02, 5.00000000e+02]])

The cost function is:

Cost=Σᵢ₌₁^{N}^{ₛᵤₚₚₗᵢₑᵣₛ}Cᵢ+Pᵢ,

where C is the price for proppant from the supplier and P is the amount of proppant supplied. The stock available from each supplier is a constraint.

The array x provides the amount of proppant that should be acquired from each of the sources to achieve an optimal proppant cost. The solution suggests that 500 pounds of proppant should be acquired from the fourth source, 1000 pounds should be acquired from the first source, 500 pounds should be acquired from the third source, and no proppant should be acquired from the second source. The optimizer picks the first, third, and fourth sources because the proppant from these sources is provided at low, high range prices. Using these suppliers will minimize costs for the proppant required for the fracturing job at the shale site. The solution is almost the same in the case of using the machine-learning, neural network model for the simulation. The amount of proppant to be acquired from the third source drops to 400 pounds. The rest of the solution remains exactly the same.

The optimal distribution of water from the available sources in this example can be projected by maximizing NPV and minimizing cost. The optimal solution in this example computed by the Bayesian optimizer is at least approximately the same using the two models:

x: array([[1000., 0., 555.91161596, 500,]]).

The cost function is:

Cost=Σᵢ₌₁^{N}^{_{freshwatersources}}CᵢWᵢ+loCₒₙₛᵢₜₑWₒₙₛᵢₜₑ,

where C is the price for by the freshwater source, Cₒₙₛᵢₜₑ is the price for onsite water treatment, W is the amount of water supplied, and to is the recovery factor. The flow capacity available from each source is a constraint.

The array x provides the amount of water that should be acquired from each of the sources to achieve an optimal water cost. The total amount of water was assumed to be 2000 gallons and the recovery factor was assumed to be 0.9. The solution suggests that 500 gallons of water should be acquired from onsite water treatment, 1000 gallons should be acquired from the first source, 555 gallons should be acquired from the third source, and no water should be acquired from the second source. The optimizer picks onsite treatment plus the third, and fourth sources because the water from these sources is provided at low, high range prices. Using these suppliers will minimize costs for the water required for the fracturing job at the shale site.

In some aspects, a system for shale field wellbore configuration control according to one or more of the following examples. As used below, any reference to a series of examples is to be understood as a reference to each of those examples disjunctively (e.g., “Examples 1-4” is to be understood as “Examples 1, 2, 3, or 4”).

### EXAMPLE 1

A system includes a processor, and a non-transitory memory device with instructions that are executable by the processor to cause the processor to perform operations. The operations include receiving resource supply data associated with a shale field to be penetrated by at least one wellbore, simulating production from the shale field using the resource supply data to determine constraints and decision variables for the at least one wellbore, and optimizing a multi-objective function of the decision variables subject to the constraints using Bayesian optimization to produce at least one controllable parameter for at least one of formation or stimulation of the at least one wellbore.

### EXAMPLE 2

The system of example 1, wherein the operations further include applying the at least one controllable parameter to equipment for formation or stimulation of the at least one wellbore in the shale field.

### EXAMPLE 3

The system of example(s) 1-2, wherein the at least one controllable parameter includes at least one of wellbore length, number of wells, or number of fractures.

### EXAMPLE 4

The system of example(s) 1-3, wherein the at least one controllable parameter includes at least one of proppant distribution from a plurality of proppant sources or water distribution from a plurality of water sources.

### EXAMPLE 5

The system of example(s) 1-4, wherein the operation of simulating production includes modeling the production from the shale field using a linear model.

### EXAMPLE 6

The system of example(s) 1-5, wherein the operation of simulating production includes modeling the production from the shale field using a hybrid physics-based machine-learning model.

### EXAMPLE 7

The system of example(s) 1-6, wherein the operation of simulating production includes simulating a drilling schedule, fracturing, a reservoir, artificial lift, and power demand.

### EXAMPLE 8

A method includes receiving, by a processor, resource supply data associated with a shale field to be penetrated by at least one wellbore, simulating, by the processor, production from the shale field using the resource supply data to determine constraints and decision variables for the at least one wellbore, and optimizing, by the processor, a multi-objective function of the decision variables subject to the constraints using Bayesian optimization to produce at least one controllable parameter for at least one of formation or stimulation of the at least one wellbore.

### EXAMPLE 9

The method of example 8 includes applying the at least one controllable parameter to equipment for formation or stimulation of the at least one wellbore in the shale field.

### EXAMPLE 10

The method of example(s) 8-9, wherein the at least one controllable parameter includes at least one of wellbore length, number of wells, or number of fractures.

### EXAMPLE 11

The method of example(s) 8-10, wherein the at least one controllable parameter includes at least one of proppant distribution from a plurality of proppant sources or water distribution from a plurality of water sources.

### EXAMPLE 12

The method of example(s) 8-11, wherein simulating production includes modeling the production from the shale field using a linear model.

### EXAMPLE 13

The method of example(s) 8-12, wherein simulating production includes modeling the production from the shale field using a hybrid physics-based machine-learning model.

### EXAMPLE 14

The method of example(s) 8-13, wherein simulating production includes simulating a drilling schedule, fracturing, a reservoir, artificial lift, and power demand.

### EXAMPLE 15

A non-transitory computer-readable medium includes instructions that are executable by a processor for causing the processor to perform operations for wellbore configuration control. The operations include receiving, by a processor, resource supply data associated with a shale field to be penetrated by at least one wellbore, simulating, by the processor, production from the shale field using the resource supply data to determine constraints and decision variables for the at least one wellbore, and optimizing, by the processor, a multi-objective function of the decision variables subject to the constraints using Bayesian optimization to produce at least one controllable parameter for at least one of formation or stimulation of the at least one wellbore.

### EXAMPLE 16

The non-transitory computer-readable medium of example 15, wherein the operations further includes applying the at least one controllable parameter to equipment for formation or stimulation of the at least one wellbore in the shale field.

### EXAMPLE 17

The non-transitory computer-readable medium of example(s) 15-16, wherein the at least one controllable parameter includes at least one of wellbore length, number of wells, or number of fractures.

### EXAMPLE 18

The non-transitory computer-readable medium of example(s) 15-17, wherein the at least one controllable parameter includes at least one of proppant distribution from a plurality of proppant sources or water distribution from a plurality of water sources.

### EXAMPLE 19

The non-transitory computer-readable medium of example(s) 15-18, wherein the operation of simulating production includes modeling the production from the shale field using at least one of a linear model or a hybrid physics-based machine-learning model.

### EXAMPLE 20

The non-transitory computer-readable medium of example(s) 15-19, wherein the operation of simulating production includes simulating a drilling schedule, fracturing, a reservoir, artificial lift, and power demand.

The foregoing description of the examples, including illustrated examples, has been presented only for the purpose of illustration and description and is not intended to be exhaustive or to limit the subject matter to the precise forms disclosed. Numerous modifications, combinations, adaptations, uses, and installations thereof can be apparent to those skilled in the art without departing from the scope of this disclosure. The illustrative examples described above are given to introduce the reader to the general subject matter discussed here and are not intended to limit the scope of the disclosed concepts.

What is claimed is:

1. A system comprising:
a processor; and
a non-transitory memory device comprising instructions that are executable by the processor to cause the processor to perform operations comprising:
receiving resource supply data associated with a shale field to be penetrated by at least one wellbore;
simulating production from the shale field using the resource supply data to determine constraints and decision variables for the at least one wellbore; and
optimizing a multi-objective function of the decision variables subject to the constraints using Bayesian optimization to produce at least one controllable parameter for at least one of formation or stimulation of the at least one wellbore.

2. The system of claim 1, wherein the operations further comprise applying the at least one controllable parameter to equipment for formation or stimulation of the at least one wellbore in the shale field.

3. The system of claim 1, wherein the at least one controllable parameter comprises at least one of wellbore length, number of wells, or number of fractures.

4. The system of claim 1, wherein the at least one controllable parameter comprises at least one of proppant distribution from a plurality of proppant sources or water distribution from a plurality of water sources.

5. The system of claim 1, wherein the operation of simulating production comprises modeling the production from the shale field using a linear model.

6. The system of claim 1, wherein the operation of simulating production comprises modeling the production from the shale field using a hybrid physics-based machine-learning model.

7. The system of claim 1, wherein the operation of simulating production includes simulating a drilling schedule, fracturing, a reservoir, artificial lift, and power demand.

8. A method comprising:
receiving, by a processor, resource supply data associated with a shale field to be penetrated by at least one wellbore;
simulating, by the processor, production from the shale field using the resource supply data to determine constraints and decision variables for the at least one wellbore; and
optimizing, by the processor, a multi-objective function of the decision variables subject to the constraints using Bayesian optimization to produce at least one controllable parameter for at least one of formation or stimulation of the at least one wellbore.

9. The method of claim 8, further comprising applying the at least one controllable parameter to equipment for formation or stimulation of the at least one wellbore in the shale field.

10. The method of claim 8, wherein the at least one controllable parameter comprises at least one of wellbore length, number of wells, or number of fractures.

11. The method of claim 8, wherein the at least one controllable parameter comprises at least one of proppant distribution from a plurality of proppant sources or water distribution from a plurality of water sources.

12. The method of claim 8, wherein simulating production comprises modeling the production from the shale field using a linear model.

13. The method of claim 8, wherein simulating production comprises modeling the production from the shale field using a hybrid physics-based machine-learning model.

14. The method of claim 8, wherein simulating production includes simulating a drilling schedule, fracturing, a reservoir, artificial lift, and power demand.

15. A non-transitory computer-readable medium that includes instructions that are executable by a processor for causing the processor to perform operations for wellbore configuration control, the operations comprising:
receiving, by a processor, resource supply data associated with a shale field to be penetrated by at least one wellbore;
simulating, by the processor, production from the shale field using the resource supply data to determine constraints and decision variables for the at least one wellbore; and
optimizing, by the processor, a multi-objective function of the decision variables subject to the constraints using Bayesian optimization to produce at least one controllable parameter for at least one of formation or stimulation of the at least one wellbore.

16. The non-transitory computer-readable medium of claim 15, wherein the operations further comprise applying the at least one controllable parameter to equipment for formation or stimulation of the at least one wellbore in the shale field.

17. The non-transitory computer-readable medium of claim 15, wherein the at least one controllable parameter comprises at least one of wellbore length, number of wells, or number of fractures.

18. The non-transitory computer-readable medium of claim 15, wherein the at least one controllable parameter comprises at least one of proppant distribution from a plurality of proppant sources or water distribution from a plurality of water sources.

19. The non-transitory computer-readable medium of claim 15, wherein the operation of simulating production comprises modeling the production from the shale field using at least one of a linear model or a hybrid physics-based machine-learning model.

20. The non-transitory computer-readable medium of claim 15, wherein the operation of simulating production includes simulating a drilling schedule, fracturing, a reservoir, artificial lift, and power demand.
